(19) United States
(12) Patent Application Publication
(10) Pub. No.: US 2008/0120909 A1
(43) Pub. Date: May 29, 2008

(54) Access control apparatus

(76) Inventors: Gregor Ponert, Salzburg (AT); Kurt Wallerstorfer, Irrsdorf (AT)

Correspondence Address: FLYNN THIEL BOUTELL & TANIS, P.C., 2026 RAMBLING ROAD, KALAMAZOO, MI, 49008-1631, US

(21) Appl. No.: 11/513,823

(22) Filed: Aug. 31, 2006

(51) Int. Cl. E05F 15/20

(52) U.S. Cl. 49/31

(57) ABSTRACT

An access control apparatus has a blocking device (1) that is actuated by an actuator, and an authentication reader (7), upon reading a valid access authorization the blocking device (1) moving into the release position. For detecting a wheel chair (15) and/or pram in the area of the blocking device (1) a sensor (13) is provided, which does not activate the actuator for moving the blocking device (1) from the release position into the blocking position until the wheel chair (15) or pram has left its detection area.

The invention relates to an access control apparatus according to the preamble of the claim 1.

Such access control apparatuses are already known. The blocking device often consists of a turning blocking device with a rotatable rotating element. According to EP 0 806 676 B1 the rotating element can have only one single barrier arm rotatable between the individual blocking positions through 360 degrees. After a valid access authorization has been read, the barrier arm is turned by the actuator in a first partial turn from the blocking position downward into the release position. Furthermore, a people sensor is provided, which activates the actuator in such a way that on detecting a person in the area of the blocking device the barrier arm in a second partial turn again is moved into the blocking position.

Access control apparatuses are used e.g. in stadiums, fairs, public swimming pools, amusement parks and a multiplicity of further institutions, which are visited, among others, by wheel chair users or by persons with small children in prams. Since a turnstile or similar turning blocking device cannot be passed with a wheel chair or pram, beside the turnstile being the main entrance a separate entrance for wheel chair users and for persons with children has to be provided, e.g. a motor-driven swinging door. For manually actuating the blocking device at the separate entrance a checking person has to be assigned.

While the main entrance with the turnstile can be passed by the persons going through only when a valid authorization has been determined by the access authorization reader, at the separate entrance such automatic check does not take place. Apart from additional personnel expenses for the checking person such a separate entrance has the disadvantage that it can be misused by inattention or with the agreement of the checking person.

Therefore, it is the problem of the invention to provide a personal access control apparatus having a blocking device, which without any greater additional effort also permits access control for wheel chairs and prams.

This is achieved according to the invention by the access control apparatus characterized in claim 1. Advantageous embodiments of the invention are specified in the subclaims.

According to the invention the blocking device is moved into the release position, when the access authorization reader has read a valid access authorization and subsequently activates the actuator accordingly. When a person without wheel chair or pram passes the entrance, preferably he is detected by a people sensor that activates the actuator in such a way that the blocking device is moved into the blocking position not until the person has passed the released blocking device.

A wheel chair or pram is detected by the sensor for the detection of wheel chairs or prams provided according to the invention, and said sensor activates the actuator in such a way that the blocking device is not moved into the blocking position until the wheel chair or the pram has left the detection area of this sensor.

Therefore, according to the invention only one single entrance is required as to reliably check both walking persons and wheel chair users or pram pushing persons. I.e., a separate entrance for wheel chairs and prams is no longer necessary. Moreover, headcount saving can be achieved because personnel for checking the separate access is no longer needed. Since the blocking device allows access only upon the access authorization reader reads a valid access authorization, wheel chair users as well as walking persons are checked.

For detecting a wheel chair or pram one or a plurality of optoelectronic sensors such as light scanners or light barriers can be used, their detection areas being adapted such that they are able to distinguish between a wheel chair or pram and a walking person. An electronic picture processing system allowing such differentiation can also be used. But since a wheel chair or pram largely consists of metal, an inductive sensor for the detection of wheel chairs and/or prams is especially preferred. Here the inductive sensor can be formed as an induction loop that is embedded in the bottom of the entrance lane in the area of the blocking device.

The blocking device cannot allow access before the people sensor detects a person, a wheel chair or pram. But substantial is that in case of a wheel chair or pram the blocking device does not take up its blocking position before the wheel chair or pram has passed the entrance lane such that it cannot be blocked by the closing blocking device. Therefore, according to the invention the actuator is not activated as to move the blocking device from the release position into the blocking position by the sensor for the detection of wheel chairs and/or prams until the wheel chair or pram has left the detection area of the wheel chair and/or pram sensor. As to ensure that the closing blocking device does not block the wheel chair or pram, different measures can be taken. The detection area of the wheel chair and/or pram sensor in relation to the area of the blocking device can be adapted such that the wheel chair or pram has left the area of the blocking device before the blocking device closes. Furthermore, a time-oriented control system can be provided, so that the actuator does not close the blocking device before a predetermined period has passed after the wheel chair or pram had left the detection area of the sensor. Furthermore, it is possible to provide a second sensor for the detection of wheel chairs and/or prams arranged in the direction of passage after the first sensor for the detection of wheel chairs and/or prams, the actuator not closing the blocking device before the wheel chair or pram has reached the detection area of the second sensor.

A pram with a small child often can pass an access control apparatus without an access authorization for the small child being required. But usually adults in wheel chairs are not granted such privileged treatment. In those countries where a special treatment for handicapped people is considered a discrimination it is even impermissible to let wheel chair users pass an access being subject to charges without having an access authorization. Therefore, there is the problem that persons pushing a pram must be allowed to pass the access control apparatus with only one access authorization, whereas for persons pushing a wheel chair the access is only released upon reading a valid access authorization for the wheel chair user and a valid access authorization for the person pushing the wheel chair. But in practice this problem is of minor importance. Adult wheel chair users are used to buy an access authorization for themselves, so that the exceptional case, that the wheel chair user does not have an access authorization can be accepted.

I.e., when a pram or a wheel chair reaches the passageway, on reading the access authorization of only one person the blocking device is moved into the release position, it remaining in the release position until the pram or wheel chair has left the detection area of the sensor for the detection of wheel chairs and/or prams and in addition the pushing person has left the detection area of the people sensor. Not until then the blocking device is moved from the release position into the blocking position.

If there is to be excluded, that an adult wheel chair user and the person pushing the wheel chair can pass the passageway with only one access authorization, in contrast to a small child in a pram and the person pushing the pram, there can be provided a device for classifying between a pram with a small child and a wheel chair with an adult person, for example with the help of a balance disposed in the entrance lane. The classification device can also be formed by a picture recording unit with downstream picture processing system and picture evaluation. Besides, the people sensor can be formed in the same way as the classification device.

The actuator preferably is a motor, in particular an electromotor. But it can also be formed e.g. by a solenoid, a piston/cylinder unit actuatable by a pressure medium, e.g. compressed air, or by another drive.

The access control apparatus according to the invention can be formed as a turning blocking device. For example, a turning star with two barrier arms, offset by about 120 degrees or 240 degrees, is used. But preferably the turning star has only one barrier arm. The rotation axis of the turning blocking device can be arranged vertical, but for space-saving reasons preferably a turning star is used, the rotation axis of which in relation to the horizontal line is inclined by 30 degrees to 60 degrees, preferably 40 degrees to 50 degrees. The angle of the barrier arm in relation to the rotation axis of the turning star preferably is 30 degrees to 60 degrees, in particular 40 degrees to 50 degrees. In its downward release position the barrier arm extends into the passageway with a maximum angle of 10 degrees in relation to the vertical. If the turning star has two turning arms, the two turning arms enclose an angle of about 120 degrees.

When a turning star with only one barrier arm is used, between two blocking positions the angle of rotation of the barrier arm is 360 degrees. If a valid access authorization is read, the single barrier arm in a first partial turn is turned from the blocking position from the top to the bottom into the release position. The rotation angle of the first partial turn can range between 90 degrees to 270 degrees, in particular 110 degrees to 250 degrees. After the wheel chair or pram has left the detection area of the sensor for the detection of wheel chairs and/or prams the barrier arm is turned onward in a second partial turn in order to again take up the blocking position. A person pushing a pram or a wheel chair is detected as such by a simultaneous response or a response of the sensor for the detection of wheel chairs and/or prams and shortly thereafter the response of the people sensor, so that the barrier arm remains in the release position until the pushing person has reached at least a position from which the barrier arm can push onward the person with the second partial turn. It is not necessary to completely exclude the possibility that the barrier arm does not come into contact with the pushing person during the second partial turn, in particular when the rotating speed of the second partial turn is limited. Slightly touching the pushing person does hardly impede the comfort of this person, but has the advantage, that for psychological reasons the passage speed of the person pushing the wheel chair or pram is increased. For the same reason a wheel chair user may be pushed onward by the barrier arm during the second partial turn.

In case of a walking person, who neither pushes a pram nor a wheel chair, the barrier arm remains in the release position as long as the people sensor has detected, that the person has reached at least a position where he is touched by the barrier arm at most in the second partial turn in order to push him onward.

The access authorization reader can be formed by a non-contacting reader, in particular for reading RFID transponders with access authorization stored thereon. But it can also be a dip reader for example for magnetic cards, bar code cards, chip cards or similar cards. The people sensor can be formed, for example, as an optoelectronic sensor.

In the following an embodiment of the access control apparatus according to the invention is explained in more detail by way of example with reference to the attached Figure.

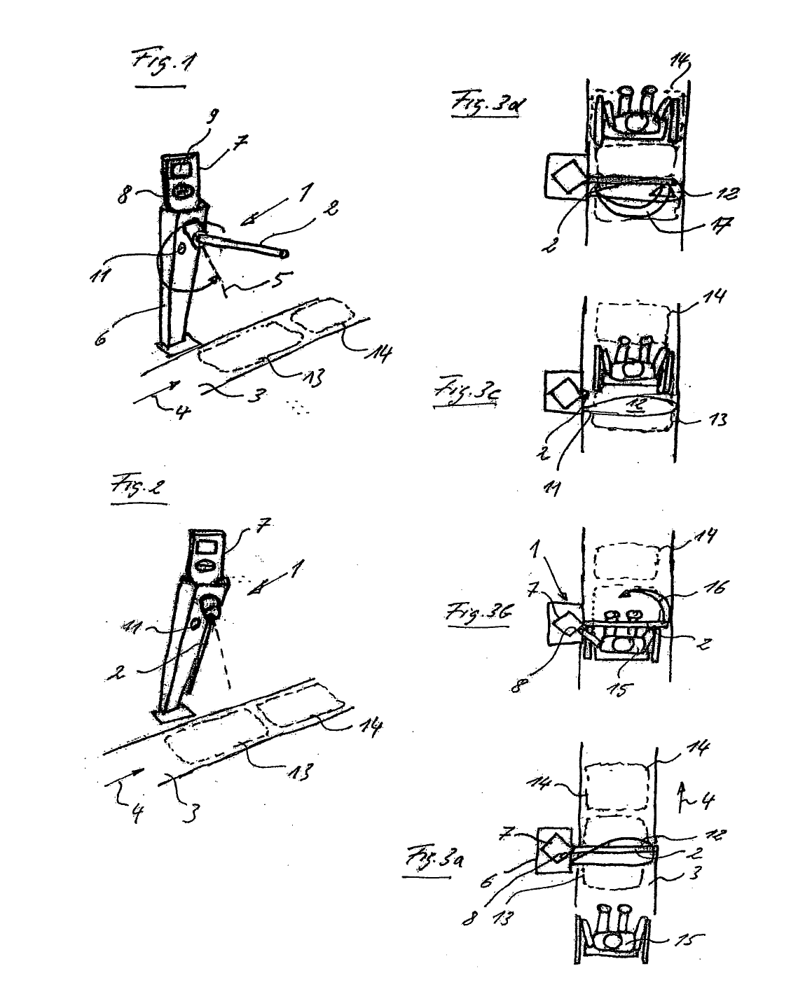

FIGS. 1 and 2 schematically show a perspective depiction of the access control apparatus in the blocking or release position; and

FIGS. 3a through 3d show a schematic plan view onto a wheel chair user, who approaches the control apparatus (FIG. 3a), they show the wheel chair user when inserting an access authorization ticket into the reader of the access control apparatus (FIG. 3b), when passing the access control apparatus (FIG. 3c), and after the passage of the access control apparatus that is in the next blocking position (FIG. 3d).

According to FIGS. 1 and 2 access control apparatus has blocking device 1 in the form of a turning star, which is driven by a not shown electromotor as an actuator. Blocking device 1 is provided with barrier arm 2 for blocking passageway 3, which is passed in the direction of the arrow 4.

Blocking device 1 has rotation axis 5, which in relation to the horizontal line is inclined by about 45 degrees. The angle enclosed by barrier arm 2 and rotation axis 5 is about 45 degrees. While barrier arm 2 in the blocking position according to FIG. 1 is turned into a roughly horizontal position and thus blocks access 3, in the release position according to FIG. 2 it is turned perpendicularly downwards, so that access 3 is released.

Access control apparatus has a frame with housing 6, wherein actuator or rotary drive, i.e. electromotor and transmission unit, and electronic control system are disposed. On housing 6 is disposed further housing 7, wherein is provided a dip reader as an access authorization reader e.g. for magnetic cards with access authorization stored thereon, which via card mouth 8 are inserted into the dip reader. Display 9 in housing 7 gives information to the user, e.g. “Gate Open”.

Furthermore, in housing 6 is provided an optoelectronic sensor as a people sensor 11, the detection area 12 of which is shown in FIGS. 3a, 3c and 3d, but for clarity's sake has been omitted in FIG. 3b.

Into the bottom of the entrance lane 3 are embedded a first and a second induction loop as a first sensor 13 and second sensor 14 for the detection of wheel chairs and prams.

When wheel chair user 15 approaches passageway 3 according to FIG. 3a, barrier arm 2 is in a blocking position (FIG. 1). After the card has been inserted into the card mouth 8 according to FIG. 3b and the reading unit has read a valid card, the motor or the transmission unit is activated such that barrier arm 2 in a first partial turn according to arrow 16 is turned forward and downward into the release position (FIG. 2). Wheel chair user 15 according to FIG. 3c here is on the first sensor 13 for the detection of wheel chairs and prams, which activates the motor or the motor transmission such that barrier arm 2 remains in the release position. When wheel chair user 15 according to FIG. 3d has left first sensor 13 and reaches second sensor 14, blocking device 1 is activated such that barrier arm 2 in a second partial turn is turned upward according to arrow 17 from the release position into the new blocking position.

When wheel chair user 15 is pushed by a (not shown) person, this person is detected by people sensor 11, the detection area 12 of which is adapted such that barrier arm 2 remains in the release position until the pushing person has reached at least the position where barrier arm 2 can push him onward with the second partial turn. In case of a (not shown) walking person (without wheel chair or pram) barrier arm 2 after having read a valid access authorization remains in the release position until the person has reached at least the position in which barrier arm 2 can push him onward with the second partial turn.

1. A personal access control apparatus having a blocking device (1), which is activated by an actuator controlled via a control system, and having an authentication reader (7), wherein upon reading a valid access authorization the blocking device (1) is moved from the blocking position into the release position by actuating the actuator, characterized by a single passageway (3) for checking both walking persons and wheel chair users (15) or persons pushing prams, wherein is provided a sensor (13) for detecting a wheel chair (15) and/or pram in the area of the blocking device (1), which does not activate the actuator as to move the blocking device (1) from the release position into the blocking position until the wheel chair (15) or the pram has left its detection area, and a people sensor (11), which activates the actuator such that the blocking device (1) remains in the release position as long as a person is in the detection area (12) of the people sensor (11).

2. The personal access control apparatus according to claim 1, characterized in that the actuator for moving the blocking device (1) into the blocking position is activated after a predetermined period of time after the wheel chair (15) or pram has left the detection area of the sensor (13) for the detection of wheel chairs and/or prams.

3. The personal access control apparatus according to claim 1, characterized in that in the direction of passage (4) after the first sensor (13) for the detection of wheel chairs and/or prams a second sensor (14) for the detection of wheel chairs and/or prams is provided, and the actuator for moving the blocking device (1) into the closed position is not activated before reaching the second sensor (14).

4. The personal access control apparatus according to claim 1, characterized in that the first and/or second sensor (13, 14) for the detection of wheel chairs and/or prams is formed as an inductive sensor.

5. The personal access control apparatus according to claim 4, characterized in that the inductive sensor is arranged as an induction loop in the entrance lane (3).

6. The personal access control apparatus according to claim 1, characterized in that the people sensor (11) is formed as an optoelectronic sensor.

7. The personal access control apparatus according to claim 1, characterized in that the people sensor (11) is formed by a picture recording unit with downstream picture processing system and picture evaluation.

8. The personal access control apparatus according to claim 1, characterized in that the blocking device (1) is formed by a turning blocking device.

9. The personal access control apparatus according to claim 8, characterized in that the turning blocking device has only one barrier arm (2), the barrier arm (2) is turned between the individual blocking positions by 360 degrees and the rotation axis (5) of the turning blocking device (1) in relation to the horizontal line is inclined by 30 degrees to 60 degrees.

10. The personal access control apparatus according to claim 8, characterized in that the turning blocking device has two barrier arms, which are disposed offset one above the other by about 120 degrees and about 240 degrees.

11. The personal access control apparatus according to claim 9, characterized in that the barrier arm (2) and the rotation axis (5) of the turning blocking device (1) enclose an angle of 30 degrees to 60 degrees.

12. The personal access control apparatus according to claim 9, characterized in that upon reading a valid access authorization the access authorization reader activates the actuator in such a way that the one barrier arm (2) in a first partial turn is turned downward from the blocking position into the release position and the actuator for turning the barrier arm (2) in a second partial turn into the blocking position is not activated before the wheel chair (15) or pram has left the detection area of the one or first sensor (13) for the detection of wheel chairs and/or prams.

13. The personal access control apparatus according to claim 12, characterized in that the partial turn from the blocking position downward into the release position is 90 degrees to 270 degrees.
